(19) United States
(12) Patent Application Publication
(10) Pub. No.: US 2015/0264887 A1
(43) Pub. Date: Sep. 24, 2015

(54) COMBINATION PET RESTRAINT AND VEHICLE TRAVEL SYSTEM

(71) Applicant: Michael Parness, Foxfield, CO (US)

(72) Inventor: Michael Parness, Foxfield, CO (US)

(21) Appl. No.: 14/218,976

(22) Filed: Mar. 19, 2014

(51) Int. Cl. A01K 1/02; A01K 15/02; B60N 2/60; A01K 7/00

(52) U.S. Cl. CPC A01K 1/0272; A01K 7/00; A01K 15/025; B60N 2/6027; B60N 2/6063

(57) ABSTRACT

The invention relates to a novel combination pet restraint and vehicle travel system wherein a unique travel system has been created around utilizing the LATCH (Lower Anchors and Tethers for Children) mechanism and includes proprietary pet restraints, adapters, vehicle seat covers, and multiple accessories which affix thereto.

### FIELD

The invention relates to a novel combination pet restraint and vehicle travel system wherein a unique travel system has been created around utilizing the LATCH (Lower Anchors and Tethers for Children) mechanism and includes proprietary pet restraints, adapters, vehicle seat covers, and multiple accessories which affix thereto.

### BACKGROUND OF THE INVENTION

The invention most closely corresponds with USPTO Class 119/771 wherein Class 119 relates to animal husbandry and sub-class 771 includes pet transport attached to vehicles.

In its simplest form, the invention comprises a novel system wherein a pet or pets may be restrained safely in the rear seat of a vehicle using the LATCH method and wherein seat covers protect the seat as well as offering multiple accessory options which are affixed thereto.

All pet owners who travel with their pets desire them to be safe within a vehicle and indeed many states have laws requiring restraint of animals in vehicles. Further to that, pets require attention during travel whether that be hydration or simply to have a toy to play with.

### THE INVENTION SUMMARY, OBJECTS AND ADVANTAGES

Traveling with pets can be difficult and messy. Restraining pets is not only the law in many states, but the responsible pet owner wants to travel safely with their pets as well as make that travel less stressful. Using a seat cover is desirous to avoid soiling the vehicle's seat, but that provides no solution for safely restraining the pet. There is also the issue of boredom and potential anxiety a traveling pet may experience. It is well known in animal behavior sciences that a bored or anxious dog particularly may exhibit its discomfort by chewing or soiling a particular area.

Not only does the inventive restraint and travel system utilize the LATCH method, it provides several attachable seat covers, restraints, attachable toys, water dish, spare water pouches and more. The inventive system is an entire solution for pet travel within a vehicle that not only protects the pets and vehicle, but also provides tension relief and hydration for the pet, which in turn, relives some of the requirement for the pet owner to have to stop the vehicle to attend to the pet or be concerned with the pet's safety. A major benefit to the inventive system is that it does not need to be removed to receive passengers or child car seats.

Nearly every car seat and most vehicles manufactured since Sep. 1, 2002, are required to be compliant with the LATCH system. Thus, newer vehicles are equipped with the required tethers embedded in the rear seats. The lower anchors are located in the rear seat bight and the top anchor tethers are located at the top of the seat or just over the seat lip depending on vehicle model. The inventive system utilizes these child safety restraint tethers for the claimed pet restraint and travel system. The inventive system includes proprietary clamp adapters affixed to the rear seat cover which will snap over the LATCH tethers provided in the rear seat bight section of a vehicle. The adapters contain a ring wherein snap hooks receive the pet restraints and the accessories for the system.

The basic inventive main rear seat cover provides four reinforced slits to insert the snap hooks through to connect to the adapter rings which have already been connected to the LATCH system. The top portion of the seat cover utilizes the rear back tethers which are also installed on the rear seats of vehicles per the LATCH requirements. Additional reinforced slits are located mid-way up the back of the seat cover to allow for various size pets to be restrained comfortably. Depending on the height of the pet, the restraint is fed through one of the slits in the seat cover and then affixed to the LATCH tethers via the proprietary adapters. Three elasticized straps connect the seat cover top snugly while the bottom portion of the seat cover extends well past a standard vehicle seat to also cover the fabric or material on the lower front of the seat.

One of the system accessories is a storage bin which connects via the LATCH mechanism and rests on the top surface of the rear seat cover to provide storage for pet supplies during travel. Being anchored, the bin is obviously prevented from movement during sudden starts or stops and does not present a hazard to pets or passengers. A second system accessory of the travel system is a forward cover that affixes to the front vehicle seat headrests, and contains a perforated pouch wherein a fan is inserted to assist in pulling cool or warm air from the front of a vehicle to the rear to reach the traveling pet. The pouch is conveniently located in the center of the forward cover for efficient air draft and remains out of the way of the vehicle's driver and passenger. This pouch can either be simply a pocket for storage or can be perforated for the fan option. The fan can be operated by solar cell or 12V vehicle adapter.

The Application's Assignee, The Kyjen Company, currently manufactures and sells a portable collapsible water dish for pet travel which is Trademarked “Port-A-Bowl”. The inventive travel system provides a third system accessory in the form of its Port-A-Bowl affixed to the lower front of the rear seat cover so that a pet may reach water without being removed from its restraint while the bowl resists spilling during travel.

A fourth travel system accessory is a set of wrap around window panels which may be affixed to the front seat covers and extend across the rear windows of the vehicle. Elastic straps wrap around any vehicle front seat headrests and provide a universal fit. Much like an airplane window, panels can be slid to obstruct light or allow the window to be visible and allow light in. Optionally the window spaces can be storage pockets. Strapped tabs are rolled into the vehicle window to hold the panels in place and easily release upon reversing the window.

A fifth travel system accessory is a latch hook connection for attaching a toy, herein shown as a chew bone, but a pet owner may replace with its pet's favorite toy. The toy is affixed to the LATCH connector with a fairly snap clip and loop of nylon for easy installation and removal. This aides in comforting and entertaining a nervous pet, or simply a typically playful pet and extends the amount of time the owner can travel without having to comfort or entertain the pet.

A sixth travel system accessory is a hydration method for storing and dispensing potable water for the pet which may be easily accessed. The food grade latex is pliable and easy to manipulate to slide into pockets in either the top or lower front of the rear seat cover. A rubber tube protrudes from the base of the bag using simple gravity to push the water out the tube and into the pet's travel bowl. A fill cap is located at the top of the bag and serves to aide in water expulsion as air is allowed into the fill mouth.

### BRIEF DESCRIPTION OF THE DRAWINGS

The invention is described in further detail by reference to ten drawings sufficient in detail to describe the invention in which:

FIG. 1 is a perspective view of the rear seat cover;

FIG. 2 is a perspective view of the rear seat cover with the storage bin affixed;

FIG. 3 is a perspective view of the front seat cover with the fan accessory installed;

FIG. 4 is an illustrative view of the varying height pet restraint options;

FIG. 5 is a perspective view of the front seat cover with the optional storage pocket in lieu of the fan;

FIG. 6 is a view of the rear seat cover with the portable water bowl affixed;

FIG. 7 is a view of the side panels;

FIG. 8 is an illustrative view of the travel toy affixed;

FIG. 9 is a perspective view of the latch adapter; and

FIG. 10 is a perspective view of the rear seat and the portable water storage bags.

### DETAILED DESCRIPTION, INCLUDING BEST MODES OF CARRYING OUT THE INVENTION

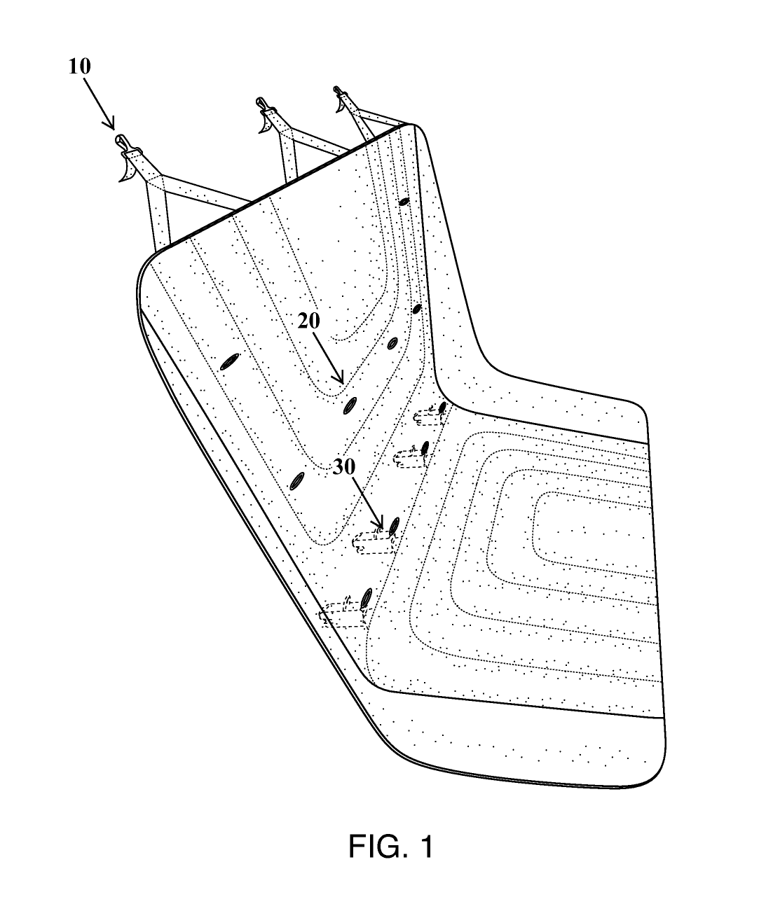

FIG. 1 illustrates the rear seat cover in its basic form and without any of the system components. Three 10 elastic LATCH compliant hooks are located at the top of the cover and affix to the standard vehicle's tethers pursuant to the LATCH guidelines. Slits 20 are located at a mid-height for pet restraint straps to be fed through to then connect to the seat bight level LATCH tethers 30, which also have slits at that lower height. The height variation provides greater comfort to pets of differing heights so that the restraint straps are not pulling or causing discomfort whether one is traveling with a Yorkshire Terrier or a German Sheppard.

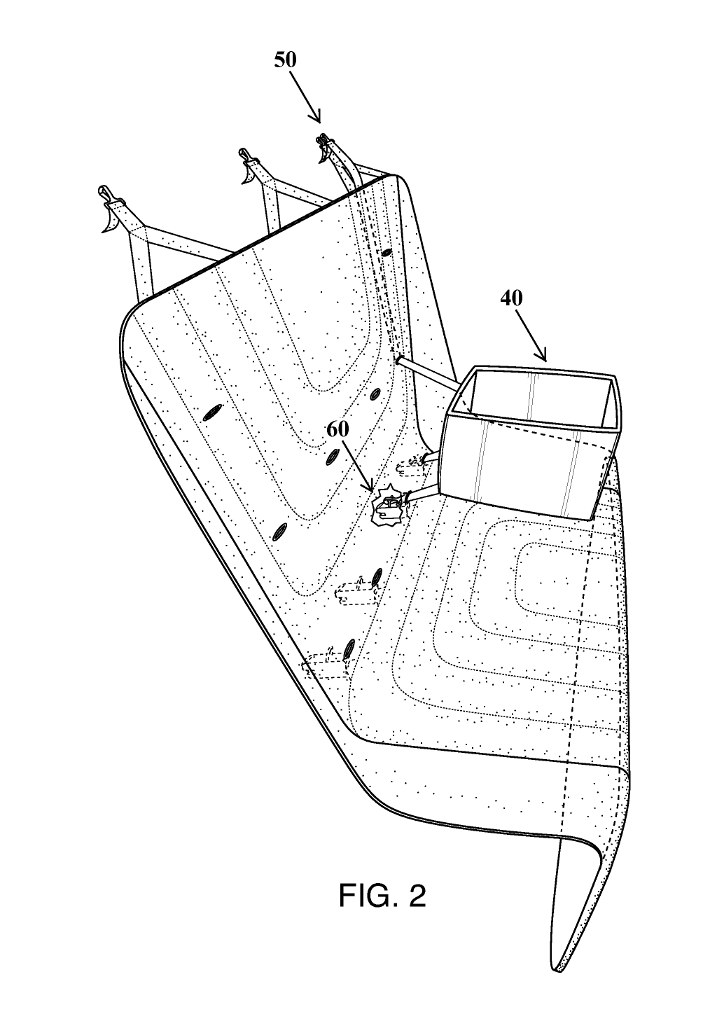

FIG. 2 shows the storage bin 40 or bucket which can be used to carry pet toys or supplies. The storage bin also utilizes the LATCH system and securely fastens via the seat bight slit 60 as well as the top anchor tether 50 employing the storage bin's own hook and strap for easy employment and deployment into the inventive travel system.

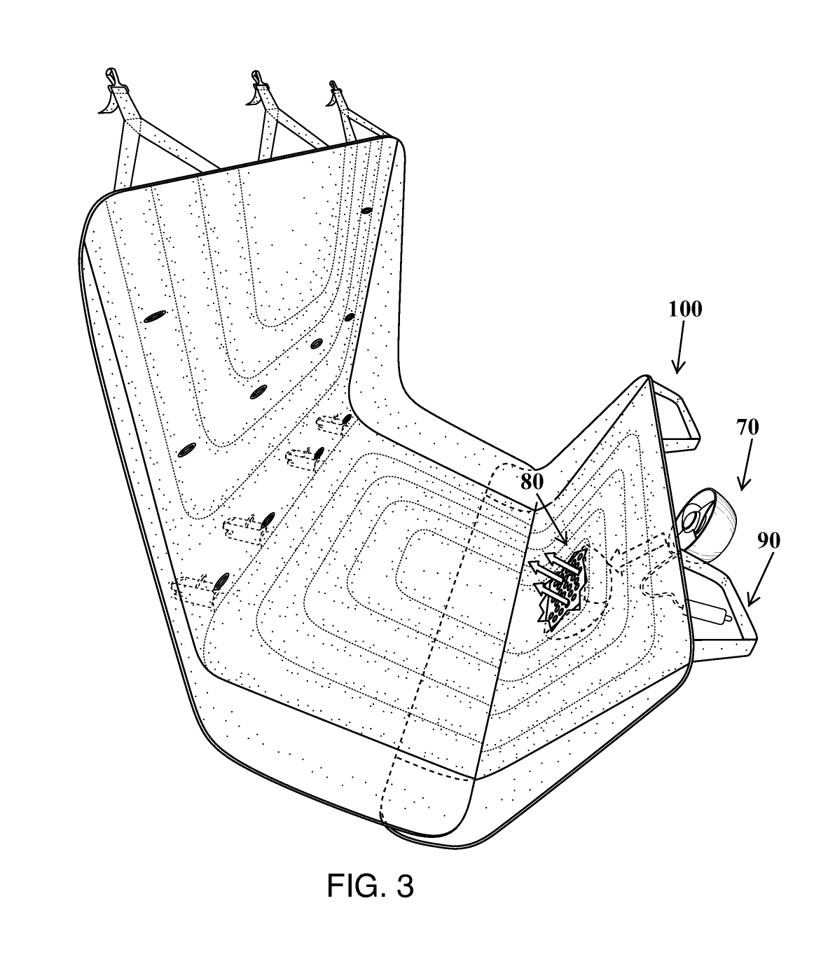

FIG. 3 illustrates the fan 70 accessory as inserted into the perforated pocket 80 of the front seat cover. When in operation, the fan helps to either direct warm air form the vehicle's heater or conversely cool air from the air conditioner to aid in the pet's comfort. It is not uncommon for pet's to get overheated especially in warmer climates, and they tend to have a lower tolerance than humans for heat. Further to that concept, it is also well known that dogs like the feeling of wind in their face, and the inventive system recognizes that comfort factor without the unsafe activity of allowing the pet to hang out of a moving vehicle's window. In this figure the 12 volt power adapter 90 is shown as would then insert into a standard vehicle power receptacle, of which, modern vehicles typically have more than one. The elastic straps 100 hook around standard vehicle front seat headrests creating a sung universal fit for the seat cover.

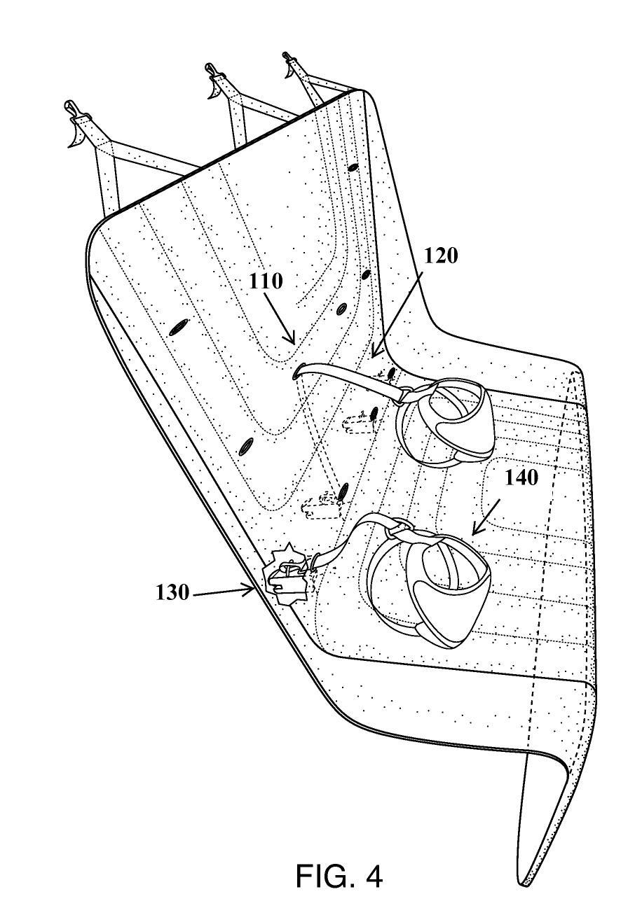

FIG. 4 provides an example of the varying height restraint harness capability. For larger dogs, 110 a mid-seat slit would be used and then the restraint straps 120 will connect at the seat bight point 130. For smaller dogs, the seat bight point slit itself is used 130 so that there is appropriate play in the strap of the restraint and the pet's movement is restricted or not commensurate with its general size. This increases the safety and comfort factor of the inventive travel system immensely. The inventive system's pet restraints 140 have two nylon back straps which surround the body of the pet and are bifurcated by a center strap which will connect to the travel system tethers. The front “bib” portion of the restraints are designed to cradle the majority of the pet's underbelly so that there is no localized pulling or pinching of the animal as with most prior art pet restraints.

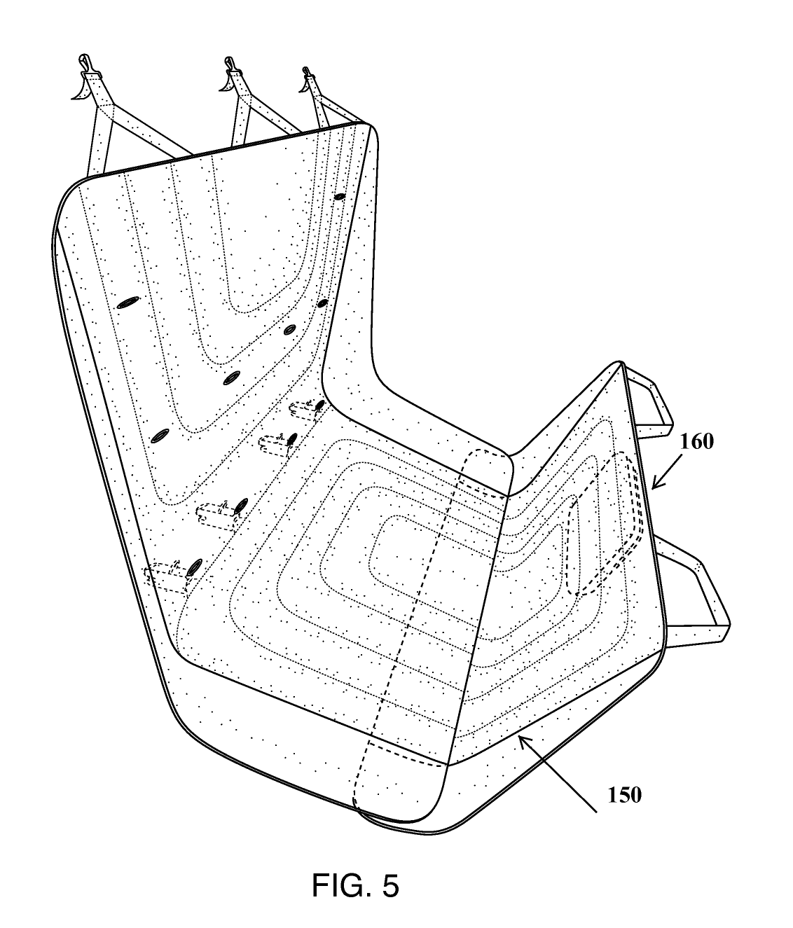

FIG. 5 is an example of the front seat cover 150 where the fan accessory is not used. Rather than the perforated slot for the fan, the slot is designed as a storage pocket 160. For pet owners who do not want the fan accessory, this is a simple yet good functional use of space as well as continued protection of the vehicle seats.

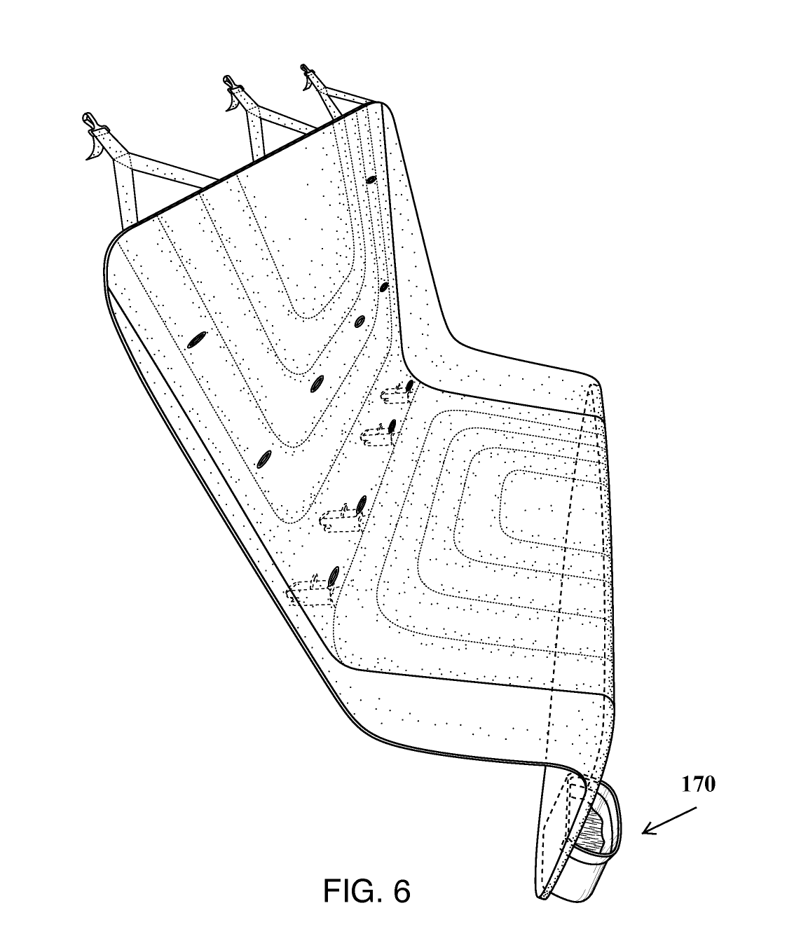

FIG. 6 shows the travel system's unique use of the Assignee's Port-A-Bowl product 170. The bowl is affixed to the rear seat cover. Per its impermeable nylon, the bowl is designed so that it is truly portable, easy to use, and will resist spilling even during movement. This makes it convenient for the pet owner to keep the pets hydrated during travel without trying to control spillage. The bowl is collapsible and can be easily removed and bundled away for storage.

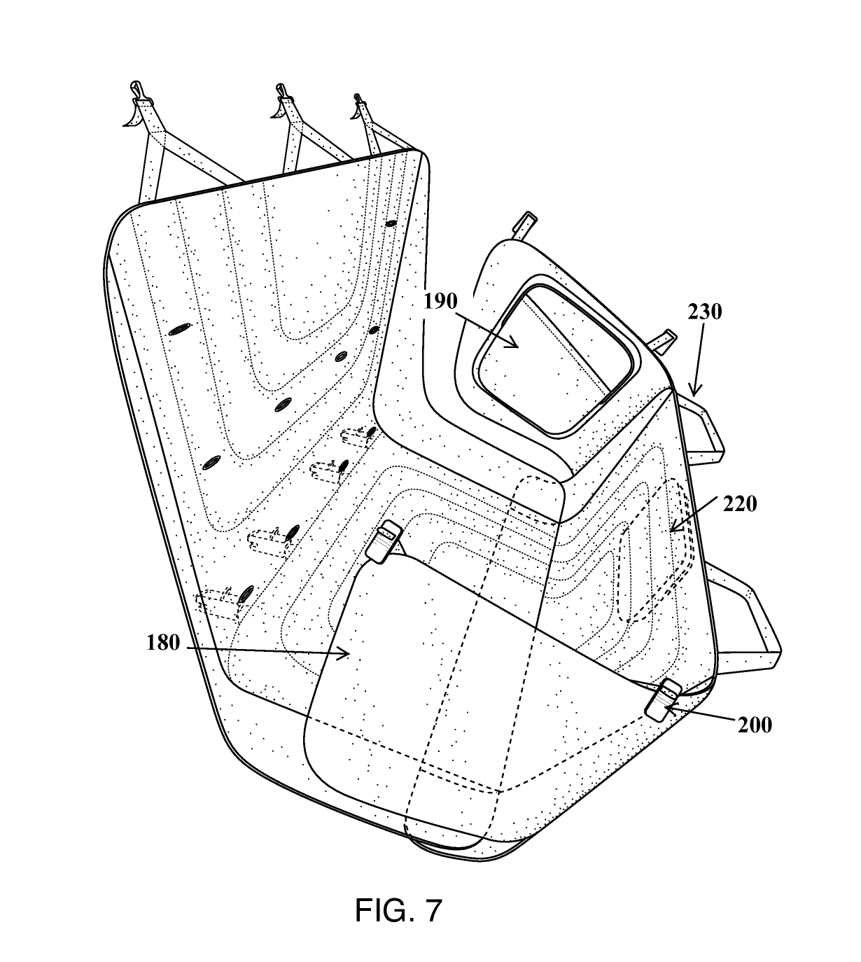

FIG. 7 illustrates the wraparound 180 panel wherein the windows may be covered 190 or may be opened to allow light to illuminate the pet's area. This can also assist in controlling excess heat. As mentioned supra, an optional mode can include a pocket rather than a sliding window feature. Tabs 200 are connected to nylon straps and are simply rolled up into the vehicle's window to assist in holding the panel in place from a vertical perspective. This makes the panel very easy to install and remove. Here, the pocket option 210 is shown rather than the earlier described fan feature. Finally, the headrest straps are also shown 220 as ready to slip around a vehicle's front seat headrests. The straps are a universal fit and will accommodate any standard vehicle's headrests.

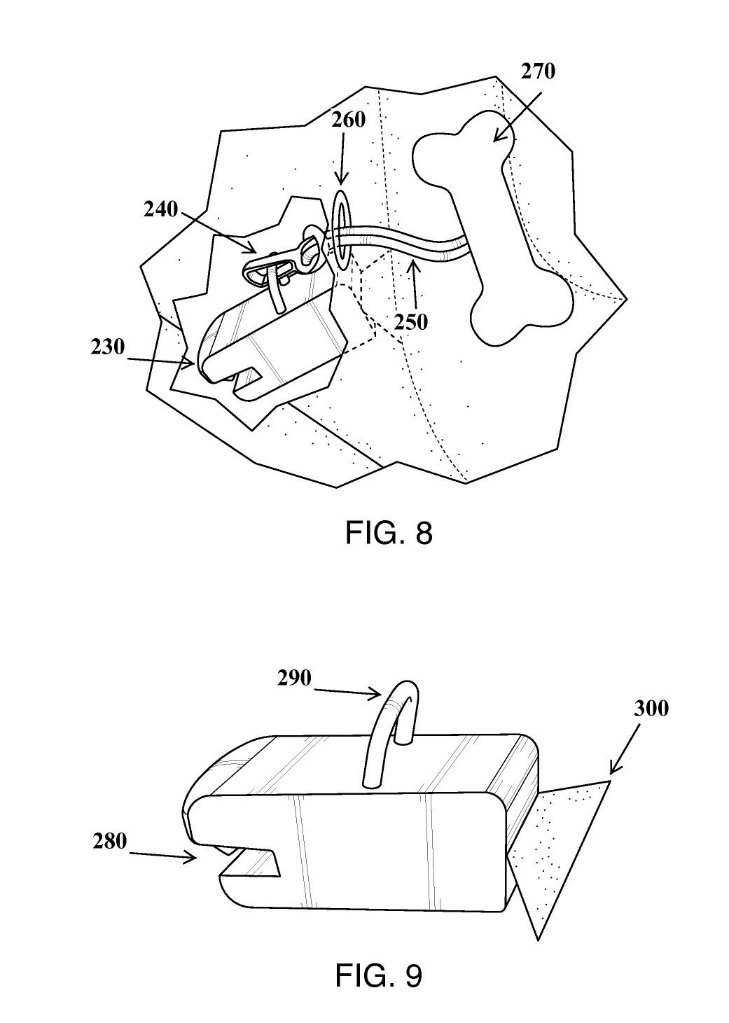

FIG. 8 shows the proprietary adapter 230 as affixed to the LATCH hook in the rear seat bight location. A snap hook 240 is used to connect the proprietary toy via a rawhide 250 or alternately a nylon strap which then feeds through one of the travel system seat cover slits 260 to the travel chew bone 270. Having something familiar to do will calm the pet and help avoid the issue of it chewing on the areas of the vehicle or even the seat cover itself. Further to that, chewing a toy or simply having something familiar to do during a trip is known to help calm a traveling pet.

FIG. 9 is the proprietary LATCH adapter. Comprised of metal alloys and plastic the adapter is a unique feature of the travel system. With a sort of “beaver mouth” 280 clamp portion which attaches to the LATCH tether already installed in a vehicle, the design prevents disengagement even when a pet may exhibit consistent movement. The squared metal loop 290 receives any snap hook restraint or accessory within the inventive system and indeed many standard snap hook connection types. The adapter is firmly affixed 300 to the inside of the rear seat cover via nylon webbing which may be removed for washing attached either by way of snaps, thumb screws, carabineer or any similar male/female attachment method.

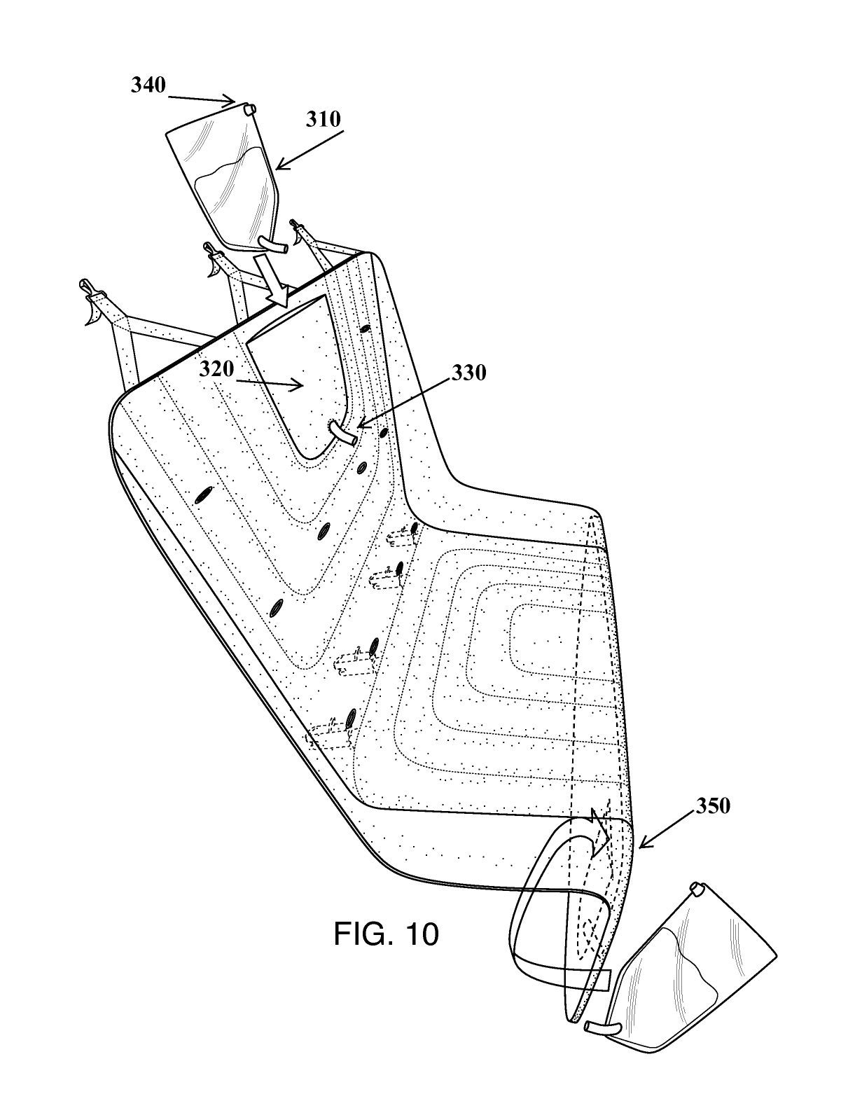

FIG. 10 illustrates the portable water bottle 310. A unique feature of the travel system, the food grade latex water bottle can slide into one of two pockets 320, 350. Specific to our present illustration, we insert the bottle into pocket 320. The evacuation tube 330 protrudes out the bottom of the pocket for easy access to the water. A fill cap 340 is located at the top of each water bottle. Not only does this provide the method to fill the bottles, but provides an obvious vapor lock release effect in that the air gap will aid gravity and force water to exit the lower tube. Depending on consumer preference, the consumer can have the water bottle located at the top, bottom, or in both locations illustrated. Proper hydration for a traveling pet is crucial, and being able to have extra potable water is a significant benefit to a traveling pet owner. If an owner prefers, the pet can drink directly from the tube as in a camelback hydration system wherein biting on the tube causes the fluid to be dispensed.

1) A combination pet restraint and vehicle travel system comprising;
a) metal and plastic adapters for connection to vehicle seats
b) a rear seat cover
b) a front seat cover
c) side rear cover panels
d) pet restraints

2) (not entered)

3) The combination pet restraint and vehicle travel system as in claim 1 wherein the rear seat cover extends over the entirety of a standard rear vehicle seat and contains slits wherein pet restraint straps are attached with the adapters and fed through to LATCH anchor points within a vehicle.

4) (not entered)

5) (not entered)

6) (not entered)

7) (not entered)

8) (not entered)

9) (not entered)

10) (not entered)

11) (not entered)
